(19) United States
(12) Patent Application Publication
(10) Pub. No.: US 2022/0079715 A1
(43) Pub. Date: Mar. 17, 2022

(54) TOOL ASSEMBLY FOR MOUNTING OF A DENTAL PROSTHESIS AND METHOD OF MOUNTING

(71) Applicant: JADE FINANCE S.A.R.L., Luxembourg (LU)

(72) Inventor: Jacques HORNBECK, Luxembourg (LU)

(21) Appl. No.: 17/430,846

(22) PCT Filed: Mar. 10, 2020
(86) PCT No.: PCT/EP2020/056391

§ 371 Date: Aug. 13, 2021

(30) Foreign Application Priority Data
Mar. 11, 2019 (LU) LU101149

(51) Int. Cl. A61C 8/00

(52) U.S. Cl. CPC A61C 8/0089; A61C 8/0068; A61C 8/0066; A61C 8/0063; A61C 8/0062

(57) ABSTRACT

A tool assembly for mounting a dental abutment includes a first tool, the first tool having an axis of elongation, a first end configured to engage, in use, the abutment, and a second end, where a first portion of the first tool at or near the first end has a peripheral wall and, opposite the wall, a first opening extending along all or part of the first portion, a second opening open in an axial direction is disposed at the first end, the tool assembly further including a second tool configured to releasably engage a fixing element, where a contiguous space is defined between the first opening and the second opening whereby, in use, the fixing element, or the fixing element attached to the second tool, may pass through the first opening and the second opening to permit secure fixing of the abutment to an implant or frame using the second tool.

### TECHNICAL FIELD

The present disclosure generally relates to techniques for the mounting of a dental prosthesis such as a crown, bridge or denture. The disclosure more particularly relates to an improved tool assembly for mounting an abutment and to method of mounting an abutment.

### BACKGROUND

Dental implants are often used when a patient requires a prosthetic device to hold one or more artificial teeth in place. Such implants are typically securely mounted to the jawbone, e.g. by surgical screws or other hygienic fixing means; and then, over a period, typically months, the bone and other tissue are permitted to grow around the implant.

A metal abutment may subsequently be securely fixed to the implant or a base thereon, and then a dental prosthesis such as a tooth crown, dental bridge or dental construction e.g. manufactured using 3D printing, may subsequently be securely fixed onto the abutment.

Typically, the metal abutment is fixed to the implant or a base thereon by means of screws or bolts—commonly called implant screws—, and tightened in place using one or more tools.

In some configurations, it may be useful to provide an inclined abutment (angulated relative to the implant screw and thereby the implant), but this may be problematical since it makes it difficult or impossible to easily access the head of the implant screw with the usual (substantially straight) tool through the angulated abutment bore. There have been a number of attempts to try to overcome this problem.

WO 2009/127880 describes an abutment/spacer element for use in a dental implant assembly having a single aperture therethrough, the single aperture comprising an implant screw access bore and an offset abutment screw bore. The implant screw access bore is designed such that, in use, the implant screw access bore is substantially coaxial with the implant screw. The implant screw access bore is inclined relative to the implant or the implant screw. The degree of incline at which the implant screw access bore is inclined relative to the implant or the implant screw may be from 0 to 10 degrees. The aperture defines a passage via which the implant screw is accessible and via which a substantially linear tool may be inserted along the longitudinal axis of the implant to engage and turn the implant screw to secure it to an implant. The opening of the aperture includes a notch or cut-away portion therein to facilitate insertion of a tool and the implant screw since the tool.

A problem is that, with known mounting/fixing tools and techniques, the tools are not such as to be easily manipulated by a dentist in the dental surgery, making fixing of elements such as abutments securely in place more difficult. Further, as the tool parts in question are of relatively small dimensions (e.g. up to 30 mm), the difficulty of manipulation raises the risk of the dentist's grip of a tool part being lost, of a tool part dislodging or falling, and even of a tool part being swallowed or even inhaled by a patient being treated.

### BRIEF SUMMARY

The disclosure provides mounting/fixing tools and mounting techniques enabling easy manipulation by a dentist, facilitating secure fixing of elements such as abutments and/or reducing or minimizing the risk of a tool part dislodging or free falling.

In order to overcome the above-mentioned issue, the present disclosure provides tool assembly for mounting a dental abutment to an implant or frame having an axis of elongation (B). The tool assembly comprises a first tool, the first tool having an axis of elongation (A), a first end configured to engage, in use, the abutment, and a second end, at least a first portion of the first tool at or near the first end having a peripheral wall and, opposite the wall, a first opening extending along all or part of the first portion, wherein a second opening open in an axial direction is disposed at the first end. The tool assembly further comprises a second tool having an axis of elongation (C) configured to releasably engage a fixing element. A contiguous space is defined between the first opening and the second opening whereby, in use, (i) the fixing element, or (ii) the fixing element attached to the second tool, may pass through the first opening and the second opening to permit secure fixing of the abutment to an implant or frame using the second tool. There is an angle β between the axis of elongation B of the implant and the axis of elongation C of the second tool.

The axis B and C are offset/angulated/not coaxial/not coinciding/not parallel. In an embodiment, the angle β between the axis of elongation B of the implant and the axis of elongation C is between 10° and 40°.

The angle β is preferably larger than 11°, 12°, 14°, 16°, 18°, 20°, 22°, 24°, 25°, 26°, 28°, 30°, 32°, 34°, 36° or 38°. The angle α is preferably smaller than 37°, 36°, 34°, 32°, 30°, 28°, 26°, 24°, 20°, 18°, 16°, 14°, 12° or 11°.

The axis of elongation B of the implant is preferably substantially vertical, i.e. in the direction of the natural teeth in the jaw.

In an embodiment, the axis of elongation A of the first tool and the axis of elongation B of the implant do not coincide/overlap. They are not parallel preferably; there is an angle α between the axis of elongation A of the first tool and the axis of elongation B of the implant.

In an embodiment the angle α between the axis of elongation B of the implant and the axis of elongation C is between 5° and 30°.

The angle α is preferably larger than 6°, 8°, 10°, 11°, 12°, 14°, 16°, 18°, 20°, 22°, 24°, 25°, 26° or 28°. The angle β is preferably smaller than 29°, 28°, 26°, 24°, 20°, 18°, 16°, 14°, 12°, 10°, 8° or 7°.

Preferably, the axis A is perpendicular/at a 90° angle with regard to the plane of the implant screw access bore.

In an embodiment, the axis of elongation C of the second tool does not coincide with the axis of elongation A of the first tool. Preferably, there is an angle θ between the axis of elongation C of the second tool and the axis of elongation A of the first tool.

In an embodiment the angle θ between the axis of elongation A of the first tool implant and the axis of elongation C of the second tool is between 5° and 15°.

The angle θ is preferably larger than 6°, 8°, 10°, 11°, 12° or 14°. The angle θ is preferably smaller than 14°, 12°, 10°, 8°, 7° or 6°.

The angle β is larger than the angle α. The angle β is larger than the angle θ. The angle α is larger than the angle θ.

A big advantage of the present tool assembly as compared to prior art assemblies described in WO 2009/127880 resides in the fact that the second tool is held at an angle with regard to the axis of elongation of the implant and the abutment. This allows the second tool to be more easily manipulated in the confined space of a buccal cavity. Indeed, if the second tool does not need to be aligned with the implant axis, it is much easier to fix the abutment to the implant since the second tool can be grasped and turned more easily especially if the implant is in the back of the mouth.

Furthermore, the abutment used in the present tool assembly does not require having a cut-out portion for the second tool to pass through, as in WO 2009/127880. Indeed since the abutment opening where the second tool passes through is at angle with regard to the axis of the implant on which it is fixed, there needs to be a cut out as otherwise the screw and the tool would not be able to be inserted at all or very difficultly. The abutment thus does not have to be made especially for the tool. This makes it less complex and less expensive. The tool of the disclosure can be used basically with any abutment.

In an embodiment, the abutment is designed such that, in use, the fixing element is substantially coaxial with the implant. The second engagement element (i.e. the implant screw access bore) may however be inclined relative to the implant or the fixing element. The degree of incline at which the second engagement element is inclined relative to the implant or the fixing element may vary, but preferably may be from 5 to 35 degrees. The second engagement element cooperates with the first engagement element of the first tool to fix the first element on the abutment. The angle between the axis A and the second engagement element (i.e. the implant screw access bore) is preferably a 90° angle, more preferably an angle between 80° and 100°.

At least part of the wall of the first portion of the first tool has preferably a partial cylindrical form.

In embodiments, along said at least part the wall has a partial cylindrical form so that, when viewed in axial cross-section, an angle formed between radii joining the axis of elongation and each of the two circumferential ends of the wall is (i) 120 degrees or more, (ii) 150 degrees or more, 180 degrees of more, or is 180 degrees. In other words, one side of the first portion of the first tool has a cut-away portion in the cylindrical part, such that, in situ, the cut-away portion provides access to the bore(s) of the abutment.

The partial cylindrical form is preferably disposed at or adjacent the first end.

Preferably, the first portion of the first tool extends part of the length of the first tool. In embodiments, the first portion of the first tool extends (i) 30-60%, (ii) 35-55%, (iii) 40-50%, (iv) 45-50% or (v) 50% of the length of the first tool.

In an embodiment, a second portion of the first tool, formed by part of the first tool other than the first portion, comprises a manually-graspable portion or is configured to releasably engage a handle for manipulation by a user.

The wall comprises, when viewed in transverse cross-section, preferably a rectangular portion at or adjacent the first end and a curved portion adjacent the second portion.

Preferably, the first portion of the first tool has a larger transverse dimension than that of the remainder of the first tool.

The tool assembly further comprises, in a preferred embodiment, at said first end, at least one first engagement element configured for releasable attachment to the abutment via cooperating at least one second engagement element on the abutment. In an embodiment, the at least one first engagement element comprises one of an external screw thread and an internal screw thread and the at least one second engagement element comprises the other of an external screw thread and an internal screw thread.

The fixing element may comprise a bolt or screw configured for screwing into the implant or frame.

The second tool comprises preferably, at a third end thereof, at least one third engagement element configured for releasable attachment to the fixing element via cooperating at least one fourth engagement element on the fixing element. In an embodiment, the cooperating at least one third engagement element and at least one fourth engagement element comprise cooperating snap-fix attachment elements.

According to another aspect of the present disclosure, there is provided a method of mounting a dental abutment to a dental implant or frame, comprising: providing a tool assembly; releasably attaching the first end of the first tool to the abutment; preferably releasably attaching the first tool together with the abutment releasably attached thereto to the implant or frame, releasably attaching the second tool to the a fixing element; passing the fixing element on the second tool through the first opening and the second opening; manipulating the second tool so as to attach the abutment to the implant or frame using the fixing element; and detaching the second tool from the a fixing element and removing the second tool through the second opening and the first opening.

Finally the first tool is detached from the abutment.

The first tool may be pre-mounted through the first engagement element onto the abutment and is used to carry/convey/transfer and position the abutment onto the implant.

An advantage of the disclosure is that the tool assembly and mounting techniques enable easy manipulation by a dentist, facilitating secure fixing of elements such as abutments, and/or reducing or minimizing the risk of a tool part dislodging or free falling.

### BRIEF DESCRIPTION OF THE DRAWINGS

Further details and advantages of the present disclosure will be apparent from the following detailed description of a non-limiting embodiment with reference to the attached drawings, wherein:

FIG. 1 is a lateral view of a tool assembly according to an embodiment, fully assembled and attached to an abutment;

FIG. 2 is a perspective view from above of the lower part of the tool assembly of FIG. 1,

FIG. 3 is a lateral exploded view of the tool assembly of FIG. 1; and

FIG. 4 is a lateral enlarged view of the junction between the lower part of the tool assembly of FIG. 1 and the abutment.

### DETAILED DESCRIPTION

In the following, like reference numerals denote like parts, and any element, design feature or method step of any embodiment may be used in combination with an element, design feature or method step of any other embodiment unless stated otherwise herein.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds or groups described in conjunction with a particular aspect, embodiment or example of the disclosure are to be understood to be applicable to any other aspect, embodiment or example described herein unless incompatible therewith.

Throughout the description and claims of this specification, the terms “aperture” and “bore” include without limitation any aperture, opening, bore, channel, passage or the like.

Throughout the description and claims of this specification, the terms “inclined”, “angulated” “offset”, “not coinciding”, and “not parallel” may be used interchangeably to refer to a component whose longitudinal axis, in use is not coaxial with the longitudinal axis of another component (for example a dental implant) with which the first component is to be used.

Unless indicated otherwise, the components described/illustrated herein may be made of titanium or surgical steel, and/or may be fabricated using turning and/or machining.

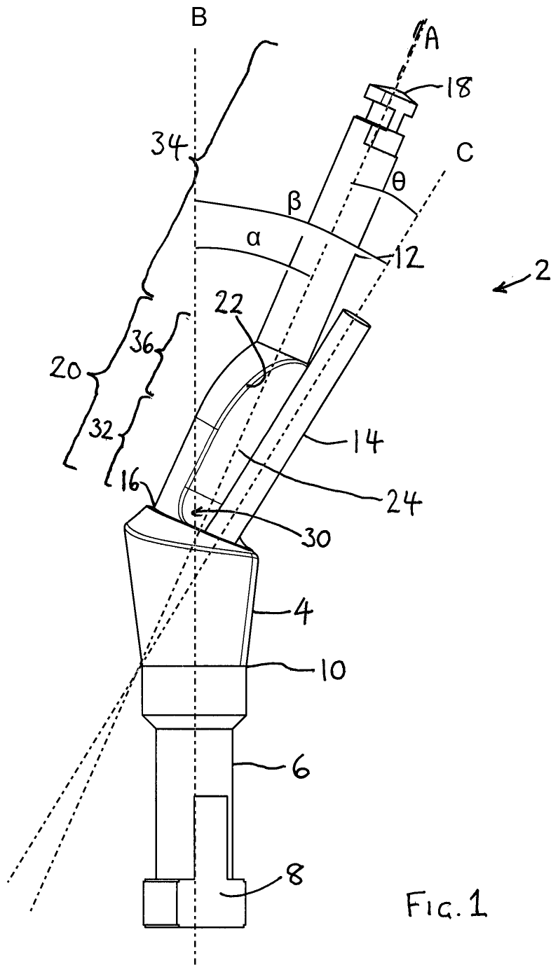

FIG. 1 is a lateral view of a tool assembly 2 according to an embodiment, fully assembled and attached to an abutment 4. As illustrated, an implant 6 is configured to be rigidly attached to a frame (not shown) already embedded in the jaw (not shown) of a patient, for example through a cooperating fixing element (not shown) engaging the implant 6 via a shaped recess 8. Alternatively, the element labelled 6 may be formed by or constitute a base or pillar integral with the frame (not shown).

The present disclosure is made in consideration of the requirement to securely fix the abutment 4 to the implant 6 or frame when the implant 6 is already securely fixed in the jawbone. In a preferred embodiment, the abutment 4 and the implant 6 have abutting flat or form-fitting surfaces (not shown in FIG. 1), as indicated at 10.

In accordance with the disclosure, the tool assembly 2 includes a first tool 12 and a second tool 14.

The first tool 12 has an axis of elongation A, a first end 16 configured to engage, in use, the abutment 4, and a second end 18. At least a first portion 20 of the first tool 12 at or near the first end 16 has a peripheral wall 22. In embodiments, the peripheral wall 22 may have a thickness up to a few mm, e.g. up to 3 mm, and/or may be up to 10% of the diameter of the first portion 20.

In the first portion 20 of the first tool 12, and opposite the wall 22, a first opening 24 extends along all or part of the first portion 20.

The axis of elongation A of the first tool 12 coincides with the axis of the aperture, opening or second engagement element 42 of the abutment 4. The axis of elongation A of the first tool 12 and the axis of elongation B of the implant 6 (and the abutment 4 when it is mounted to the implant) do not coincide/overlap. There is an angle α of between 5° and 35° between these two axes.

The axis of elongation B of the implant 6 (and the abutment when it is mounted on the implant) is substantially vertical. When the implant 6 is mounted in a substantially vertical position in the jawbone, the first tool 12 is extending/projecting at an angle α into the buccal cavity of the patient. It can thus be easily grasped and manipulated and mounted to the implant by the dentist together with the second tool.

In the context of the disclosure, “substantially vertical” is understood as the same angle as natural teeth set in the jaw and which protrude in the buccal cavity at a substantially vertical angle.

It may however be that the implant is implanted in the jaw at an angle which deflects from the vertical, depending on the configuration of the implant or denture that is fixed to the implant and on other factors like the bone quality of the jaw, the number of implants, the position of the implant in the mouth (upper jaw, lower jaw, front teeth back teeth) etc.

One disadvantage of the configuration as shown on FIG. 8 of WO 2009/127880 is that the two tools—the handle and the screwdriver—are in the each other's way when in use since the screwdriver must be inserted “behind” the handle when seen from the point of view of the dentist who installs said abutment in the mouth of a patient. This makes it difficult to tighten the screw since the handle is in the way. In the present configuration however, the two tools are not in the each other's way. The second tool (the screwdriver) is inserted via “the front” of the first tool—i.e. oriented towards the buccal cavity. It can thus be easily inserted while the first tool is in place. The screwdriver can be turned without the handle being in the way as in FIG. 8 of WO 2009/127880.

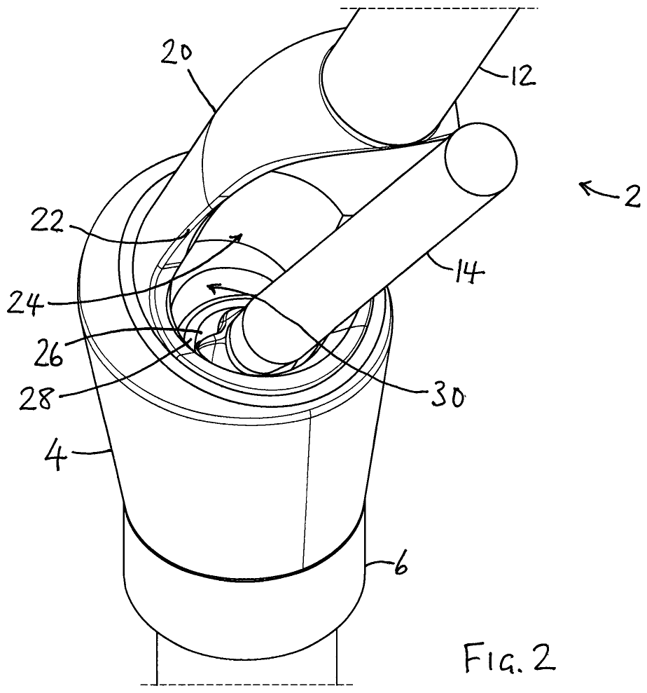

Referring briefly to FIG. 2, this is a perspective view from above of the lower part of the tool assembly 2 of FIG. 1. A second opening 26 that is open in an axial direction is disposed at the first end 16. In embodiments, the second opening 26 is circular in shape.

In accordance with the disclosure, the second tool 14 is configured to releasably engage a fixing element 28, as discussed in further detail hereinbelow.

Referring to FIGS. 1 and 2, a contiguous space 30 is defined between the first opening 24 and the second opening 26 such that, in use, (i) the fixing element 28, or (ii) the fixing element 28 attached to the second tool 14, may pass through the first opening 24 and the second opening 26 to permit secure fixing of the abutment 4 to an implant 6 or frame using the second tool 14, as discussed in further detail hereinbelow.

Returning to FIG. 1, in an embodiment, at least part 32 of the wall 22 has a partial cylindrical form. More particularly, in embodiments, along the at least part 32 of the wall 22 has a partial cylindrical form so that, when viewed in axial cross-section, an angle formed between radii joining the axis of elongation A and each of the two circumferential ends of the wall 22 is (i) 120 degrees or more, (ii) 150 degrees or more, 180 degrees of more, or is 180 degrees. In an embodiment, the part 32 with the partial cylindrical form is disposed at or adjacent the first end 16.

In an embodiment, the first portion 20 of the first tool 12 extends part of the length of the first tool 12. More particularly, in embodiments, the first portion 20 of the first tool 12 extends (i) 30-60%, (ii) 35-55%, (iii) 40-50%, (iv) 45-50% or (v) 50% of the length of the first tool 12.

In embodiments, the at least part 32 of the wall 22 comprises, when viewed in transverse cross-section, a rectangular portion at or adjacent the first end 16.

In an embodiment, a second portion 34 of the first tool 12, formed by part of the first tool 12 other than the first portion 20, comprises a manually-graspable portion or is configured to releasably engage a handle (not shown) for manipulation by a user. In embodiments, the first portion 20 comprises, when viewed in transverse cross-section, a curved part 36 adjacent the second portion 34.

In embodiments, the first portion 20 of the first tool 12 has a larger transverse dimension (e.g. diameter) than that of the remainder of the first tool 12, e.g. the second portion 34. For example, the first portion 20 may have a 100-300% larger transverse dimension (e.g. diameter) than that of the remainder of the first tool 12 so that the second tool can be inserted therethrough and have space to jiggle/wiggle.

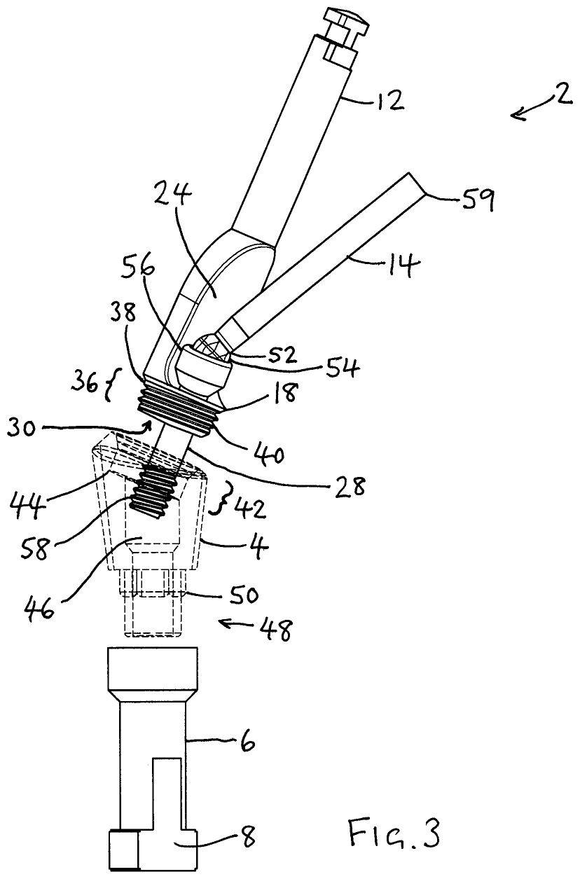

FIG. 3 is a lateral exploded view of the tool assembly 2 of FIG. 1. In an embodiment, the first tool 12 includes, at the first end 16, at least one first engagement element 36 configured for releasable attachment to the abutment 4 via a cooperating at least one second engagement element 42 on the abutment 4. The first engagement element 36 may comprise an engagement ring 38 upon which an external screw thread 40 is provided, and/or the second engagement element 42 may comprise a hollow internal ring section 44, e.g. upon which an internal screw thread (not shown) is provided. In alternative embodiments, an internal screw thread is provided on the engagement ring 38, and/or an external screw thread (not shown) is provided on the internal ring section 44.

Via the first opening 24 defined by the wall 22, the second opening 26 defined by the engagement ring 38, and the internal ring section 44, the fixing element 28 (preferably attached to the second tool 14, as shown in FIG. 3), can be advanced from the exterior of the first tool 12 by the user into a chamber 46 defined within the abutment 4.

In embodiments, at or near an end 48 of the abutment 4 opposite to the internal ring section 44 the abutment 4 includes external formations 50, e.g. in the shape of a hex nut, for engaging a correspondingly shaped recess (not shown) in the implant 6, in order for the abutment 4 to be received in the implant 6 in an immovable (i.e. non-rotatable) manner.

As seen in FIG. 3, the second tool 14 may comprise, at a third (distal) end 52 thereof, at least one third engagement element 54 configured for releasable attachment to the fixing element 28 via cooperating at least one fourth engagement element 56 on the fixing element 28. At the end of the fixing element 28 opposite to the fourth engagement element 56, the fixing element may have an external screw thread 58 or other attachment element, for fixedly engaging a corresponding attachment element (e.g. internal screw thread) within the implant 6 or frame.

In embodiments, the fixing element 28 comprises a bolt or screw configured for screwing into the implant 6 or frame. In embodiments, the cooperating at least one third engagement element 54 and at least one fourth engagement element 56 comprise cooperating snap-fix (click-fix) attachment elements. That is, the third engagement element 54 (e.g. a ball having multiple outwardly biased projections) may be configured to enable the distal end 52 of the second tool 14 to be snapped into fourth engagement element 56 (e.g. a bolt head having an internal recess or recesses for receiving the ball and/or projections; not shown).

EP 3 541 318—integrated herein by reference—describes a combination of a screw for a surgical application, and a driver for driving the screw for fastening an orthopedic implant either to a bone or to an orthopedic implant, in particular a dental component to a dental implant that can be used for the present purpose.

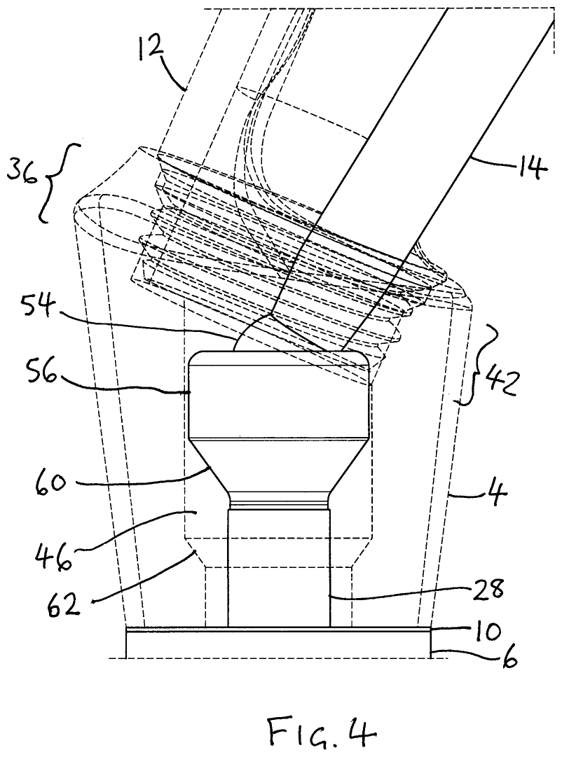

FIG. 4 is a lateral enlarged view of the junction between the lower part of the tool assembly 2 of FIG. 1 and the abutment. The first tool 12 has releasably engaged the abutment 4 such that the at least one first engagement element 36 has (e.g. screw-threadedly) engaged the cooperating at least one second engagement element 42 on the abutment 4. The third engagement element 54 has engaged the fourth engagement element 56, enabling the fixing element 28 to be pushed down (in the direction of arrow B) into the abutment 4 and implant 6. Thereafter, by the user twisting the (proximal end 59) of the second tool 14 (opposite the distal end 52, the user can screw the fixing element 28 into the implant 6 or frame.

In an embodiment, such movement (and screwing in, in the direction of arrow B) is limited by a conical section 60 coming into contact with shoulder 62 on the abutment 4.

Thus, in accordance with an embodiment, a method of mounting a dental abutment using the tool assembly described above and illustrated herein is as follows (to an extent, the order of the steps may be varied). First, the first end 16 of the first tool 12 is releasably attached to the abutment 4. Then, the second tool 14 is releasably attached to the fixing element 28. Next, the fixing element 28 is passed on the second tool 14 through the first opening 24 and the second opening 26. The user then inserts both tools in the buccal cavity and positions the abutment on the implant. The user can hold both tools in between the thumb and the index finger and easily bring them in position without risk of dropping the screw or the abutment. The user then manipulates the second tool 14 so as to attach the abutment 4 to the implant 6 or frame using the fixing element 28. Finally, the second tool 14 is detached from the fixing element 28 and the second tool 14 removed through the second opening 26 and the first opening 24. Finally the first tool 12 is detached from the abutment 4. If the user wants to take the abutment out again, he will apply the above steps in reverse order.

While embodiments have been described by reference to embodiments of survey devices having various components in their respective implementations, it will be appreciated that other embodiments make use of other combinations and permutations of these and other components.

1. A tool assembly for mounting a dental abutment to an implant or frame having an axis of elongation, the tool assembly comprising:
a first tool, the first tool having an axis of elongation, a first end configured to engage, in use, the abutment, and a second end, at least a first portion of the first tool at or near the first end having a peripheral wall and, opposite the wall, a first opening extending along all or part of the first portion, wherein a second opening open in an axial direction is disposed at the first end;
a second tool having an axis of elongation configured to releasably engage a fixing element,
wherein a contiguous space is defined between the first opening and the second opening whereby, in use, the fixing element, or the fixing element attached to the second tool, may pass, in use, through the first opening and the second opening to permit secure fixing of the abutment to the implant or frame using the second tool,
wherein there is an angle β between the axis of elongation of the implant and the axis of elongation of the second tool.

2. The tool assembly according to claim 1, wherein at least part of the wall has a partial cylindrical form.

3. The tool assembly according to claim 2, wherein along said at least part the wall has a partial cylindrical form so that, when viewed in axial cross-section, an angle formed between radii joining the axis of elongation and each of the two circumferential ends of the wall is 120 degrees or more.

4. The tool assembly according to claim 2, wherein the part with the cylindrical form is disposed at or adjacent the first end.

5. The tool assembly according to claim 1, wherein the first portion of the first tool extends part of the length of the first tool.

6. The tool assembly according to claim 1, wherein the first portion of the first tool extends 30-60% of the length of the first tool.

7. The tool assembly according to claim 5, wherein a second portion of the first tool, formed by part of the first tool other than the first portion, comprises a manually-graspable portion or is configured to releasably engage a handle for manipulation by a user.

8. The tool assembly according to claim 1, wherein the wall comprises, when viewed in transverse cross-section, a rectangular portion at or adjacent the first end and a curved portion adjacent the second portion.

9. The tool assembly according to claim 1, wherein the first portion of the first tool has a larger transverse dimension than that of the remainder of the first tool.

10. The tool assembly according to claim 1, further comprising, at said first end, at least one first engagement element configured for releasable attachment to the abutment via cooperating at least one second engagement element on the abutment.

11. The tool assembly according to claim 10, wherein the at least one first engagement element comprises one of an external screw thread and an internal screw thread and the at least one second engagement element comprises the other of an external screw thread and an internal screw thread.

12. The tool assembly according to claim 1, wherein the fixing element comprises a bolt or screw configured for screwing into the implant or frame.

13. The tool assembly according to claim 1, wherein the second tool comprises, at a third end thereof, at least one third engagement element configured for releasable attachment to the fixing element via cooperating at least one fourth engagement element on the fixing element.

14. The tool assembly according to claim 10, wherein the cooperating at least one third engagement element and at least one fourth engagement element comprise cooperating snap-fix attachment elements.

15. A method of mounting a dental abutment, comprising:
providing a tool assembly according to claim 1;
releasably attaching the first end of the first tool to the abutment;
releasably attaching the second tool to a fixing element;
passing the fixing element on the second tool through the first opening and the second opening;
manipulating the second tool so as to attach the abutment to the implant or frame using the fixing element; and
detaching the second tool from the fixing element and removing the second tool through the second opening and the first opening.
